(19) United States
(12) Patent Application Publication
(10) Pub. No.: US 2006/0239166 A1
(43) Pub. Date: Oct. 26, 2006

(54) METHOD OF DETERMINING A WRITE STRATEGY

(76) Inventor: Chih-Ching Yu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,893

(22) Filed: Apr. 20, 2005

(51) Int. Cl. G11B 7/12; G11B 7/0045

(52) U.S. Cl. 369/59.11; 369/47.53

(57) ABSTRACT

A method of determining a write strategy when storing data on an optical disc in an optical storage device includes detecting a characteristic of the optical disc, determining an initial write strategy according to the detected characteristic of the optical disc, adjusting the initial write strategy by performing a write pulse adjustment including adjusting a first edge of a write pulse in the initial write strategy by a first time unit to thereby generate an adjusted write strategy, writing data on the optical disc utilizing the adjusted write strategy, measuring reproduced signal quality values when reading the data from the optical disc, and determining a write strategy according to the reproduced signal quality values.

### BACKGROUND

The invention relates to optical storage devices, and more particularly, to determining a write strategy when storing data on an optical disc.

Examples of known recording mediums storing optically writable and rewritable information thereon include phase-change storage media and magneto-optical recording media. In writing information onto a phase-change storage medium, an information layer of the medium is irradiated with a focused laser beam, thereby partially heating and fusing the information layer. The highest temperature the information layer can reach due to the heat applied thereto or the cooling process of the layer differs depending on the intensity of the laser radiation incident thereto. Thus, the optical characteristics of the information layer, such as the refractive index thereof, are locally modifiable by modulating the intensity of the laser radiation emitted. More specifically, if the intensity of the laser radiation is higher than a predetermined reference level, part of the information layer of the recording medium that has been irradiated with the radiation is rapidly cooled from an elevated temperature so as to be amorphous. If the intensity of the laser radiation is relatively low on the other hand, the irradiated part of the information layer of the recording medium is gradually cooled from an intermediate to high temperature and therefore crystallized. The amorphous part of the information layer of the recording medium is called a “mark”, while the crystallized part is called a “space”. That is to say, the mark and space have mutually different optical characteristics in terms of their refractive indices, for example. Accordingly, binary data is storable in the information layer of the recording medium by arranging the marks and spaces in a specific pattern. As used herein, the laser radiation for use in information recording will be called “write radiation”.

In reading out information stored on a phase-change storage medium, the information layer thereof is irradiated with a laser radiation beam with an intensity low enough to not cause any phase change in the information layer and a radiation beam, which is reflected from the information layer, is detected. As used herein, the laser radiation for use in information readout will be called “readout radiation”. The mark, or the amorphous part of the information layer of the recording medium, has a relatively low reflectance, while the space, or the crystallized part of the information layer of the recording medium, has a relatively high reflectance. Accordingly, by recognizing the difference in the amount of the radiation reflected from the mark and space, a reproduced signal can be obtained.

Information can be recorded on such a recording medium by a pulse position modulation (PPM) or pulse width modulation (PWM) technique. A recording technique, which uses PWM is also called a “mark edge recording” technique. According to the PPM recording technique, marks are recorded with the space between the marks varied, and information to be written is assigned to positions of the marks. Each of these marks is represented as a pulse with a relatively short, constant pulse width. In contrast, according to the PWM technique, marks of various lengths are recorded with the space between the marks also varied, and information to be written is represented by edge positions of the marks and spaces with a variety of lengths. Generally speaking, the density of the information recorded can be higher with the PWM technique than with the PPM technique.

In performing a PWM recording, longer marks are recorded compared to the PPM recording. If long marks are recorded on a phase-change storage medium, however, the widths of those marks might be non-uniform, because the information layers of media of this type may accumulate and dissipate heat in various manners and their recording sensitivities may be greatly different from each other. It is also known that if the information layer is continuously irradiated with radiation for a long time to record a long mark therein, then the second half of the long mark is likely to increase its width because too much heat is accumulated in that part. To avoid such an unfavorable increase in mark width, a write strategy is typically utilized to control the write radiation.

FIG. 1 illustrates waveforms 100 of write radiation, shapes of marks 102 formed in the information layer, waveforms 104 of reproduced signals, and binary data 106 obtained by digitizing the reproduced signals 104 according to the related art. As shown in FIG. 1, the waveform 100 of write radiation is defined by the waveform of an electrical signal used for modulating the write radiation, which is formed by collection of “write pulses”. The power of the write radiation (hereinafter, simply referred to as “write power”) is proportional to the amplitude of each write pulse. Depending on the type of a radiation source (e.g., semiconductor laser diode), a difference may be found between the waveform of write radiation and the waveform of write pulses. However, throughout the following description, the waveforms of the write radiation and write pulses will be treated as indistinguishable from each other.

First, referring to the waveform 100 of the write radiation shown in FIG. 1, the waveform 100 is used for forming a single mark and consists of a first pulse 1, a multi-pulse train 2, and a second pulse 3, which appear one after another in this order on the time axis. The write power is modulated among peak power Pp, a first bias power Pb1 and second bias power Pb2. It should be noted that although the term “multi-pulse train” generally means a train made up of at least two pulses, just one pulse located between the first and second pulses will also be labeled as such in this description for convenience sake.

In an interval during which a single mark is being formed in the information layer by irradiating the information layer of the recording medium with the write radiation, the write power is modulated between the peak power Pp and the second bias power Pb2. As used herein, this interval will be called a “marking period”. On the other hand, in an interval during which a single space is being formed in the information layer of the recording medium, the write power is maintained at the first bias power Pb1. As used herein, this interval will be called a “spacing period”.

In general, an optical recording/reproducing apparatus has to write or read information appropriately onto/from an optical information carrier with various recording properties. Thus, if information is written on an information carrier with a relatively low recording sensitivity while keeping an average write power (i.e., an average of the write power during the marking period) constant, then the lengths and widths of marks formed in such a carrier tend to be smaller. Accordingly, after having initialized the write power of a radiation source at an appropriate value while taking the recording sensitivity of an information carrier into account, a conventional optical recording/reproducing apparatus compensates for the write power to adaptively change the lengths and widths of marks to be formed. This process is called “write power learning”. More specifically, such an optical recording/reproducing apparatus compensates for the write power by recording a relatively short mark on the information carrier for testing purposes and then modulating the write power such that the short mark can be recorded accurately. This strategy has been adopted because it has been more important than anything else to record a short mark resulting in a read signal with small amplitude.

However, a read error is still unavoidable even if the write power is compensated for by the conventional technique. Also, a relatively long mark is more likely to cause such a read error. An exemplary mark 4 is illustrated in FIG. 1. Such a mark 4 is formed if the thermal energy (or the average power applied by the write radiation during the marking period) associated with the multi-pulse train 2 is less than a minimum required level. As shown in FIG. 1, the mark 4 is relatively wide at its front and rear edges but is relatively narrow in its middle portion between the edges. A mark recorded by the conventional technique results in this unfavorable phenomenon, hereafter referred to as “middle narrowing”.

When such a mark 4 is irradiated with readout radiation, and the radiation reflected from the mark 4 is typically received at a photodetector and converted into an electrical is signal, then a read signal 5 with twin peaks is obtained as illustrated in FIG. 1. And if the read signal 5 is digitized with respect to its threshold value 6, then two discrete pulses 7 and 8 are formed. As a result, neither the precise locations of the edges of the mark 4 nor the length of the mark 4 can be recognized correctly, thus causing an error in reading the recorded data from the recording medium. In the following description, the middle portion of a mark, i.e., part of a mark located between its front and rear edges, where the level of the associated read signal is relatively low and which will be erroneously recognized as a “space” instead a part of the mark when the read signal is digitized, will hereafter be referred to as a “read-error-inducing portion”.

If an increase in the number of read errors is sensed by a system controller in the conventional optical recording/reproducing apparatus during the process of compensating for the write power, then the write power is automatically adjusted in such a manner as to reduce the read errors. The conventional compensation technique is illustrated on the right-hand side of FIG. 1. According to the conventional write power compensation technique, the power level of each pulse in the write radiation is increased by the factor of α (where α>1), thereby irradiating an optical information carrier with the write radiation with the waveform shown on the right-hand side of FIG. 1, where Pp′=α*Pp, Pb1′=α*Pb1 and Pb2′=α*Pb2. However, if all of these three power levels are increased by the same factor, then a resultant mark 10 will be much longer and wider than a desired mark 9 as shown on the right-hand side of FIG. 1. Thus, such an excessively long and wide mark 10 will result in a reproduced signal 12 with a waveform laterally expanded compared to a desired reproduced signal 11. And if that reproduced signal 12 is digitized with respect to its threshold value 6, then a mark length 14, which is represented by the width of a pulse of the binary data obtained, is longer than its appropriate length 13 as illustrated on the right-hand side of FIG. 1. As a result, neither the locations of the edges of the mark 9 nor the length of the mark 9 can be recognized correctly, thus also causing a read error.

It should be noted that such a problem is not unique to a phase-change storage medium but might happen to any other optical information carrier, e.g., a magneto-optical recording medium.

### SUMMARY OF THE INVENTION

One objective of the claimed invention is therefore to provide an improved method of determining a write strategy when storing data on an optical disc in an optical storage device, to solve the above-mentioned problems.

According to an exemplary embodiment, a method of determining a write strategy when storing data on an optical disc in an optical storage device is disclosed. The method comprises detecting a characteristic of the optical disc; determining an initial write strategy according to the detected characteristic of the optical disc; adjusting the initial write strategy by performing a write pulse adjustment including adjusting a first edge of a write pulse in the initial write strategy by a first time unit to thereby generate an adjusted write strategy; writing data on the optical disc utilizing the adjusted write strategy; measuring reproduced signal quality values when reading the data from the optical disc; and determining a write strategy according to the reproduced signal quality values.

According to another exemplary embodiment, an optical storage device is disclosed comprising an optical medium reception unit for receiving an optical medium and detecting a characteristic of the optical disc; an optical pickup for writing marks on the optical medium and reading data from the optical medium corresponding to the marks; a write pulse controller being coupled to the optical pickup for determining an initial write strategy according to the detected characteristic of the optical disc and adjusting the initial write strategy by performing a write pulse adjustment by adjusting a first edge of a write pulse in the initial write strategy by a first time unit to thereby generate an adjusted write strategy; writing data on the optical disc utilizing the adjusted write strategy; and determining a write strategy according to reproduced signal quality values; and a signal quality measuring unit being coupled to the write pulse controller and the optical pickup for measuring reproduced signal quality values when reading the data from the optical disc.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates waveforms of write radiation, shapes of marks formed in the information layer, waveforms of reproduced signals, and binary data obtained by digitizing the reproduced signals according to the related art.

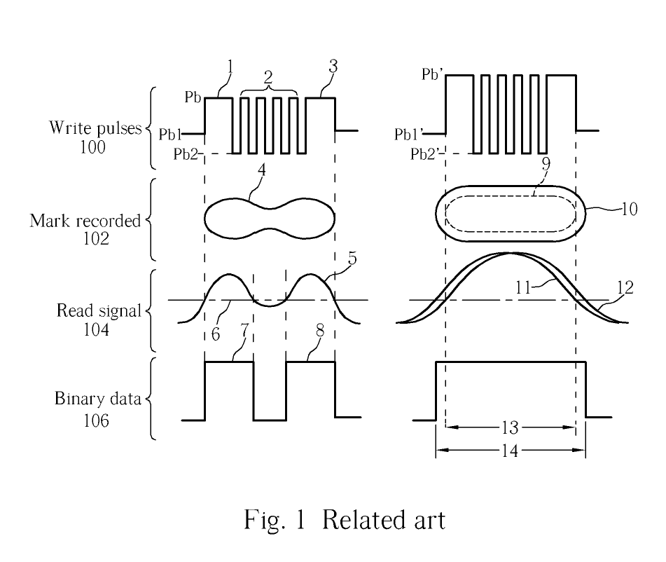

FIG. 2 shows an optical storage device according to an exemplary embodiment

FIG. 3 shows a flowchart describing a method of determining a write strategy according to an exemplary embodiment.

FIG. 4 is a write pulse waveform diagram of three different exemplary write strategies undergoing adjustment by the write pulse controller according to an exemplary embodiment.

FIG. 5 shows a flowchart describing performing the write pulse adjustment of FIG. 3 when determining the write strategy according to an exemplary embodiment.

FIG. 6 shows a diagram illustrating changes in the shape of marks written to the optical medium by adjusting the first edge Ttop1 and the second edge Ttop2 in the first pulse according to step 502 of FIG. 5.

FIG. 7 shows a diagram illustrating changes in the shape of marks written to the optical medium by adjusting the time duration Tmp of a middle pulse according to step 500 of FIG. 5.

FIG. 8 shows a flowchart describing steps for performing the tuning operations of FIG. 5 according to a first embodiment.

FIG. 9 shows a flowchart describing steps for performing the tuning operations of FIG. 5 according to a second embodiment.

### DETAILED DESCRIPTION

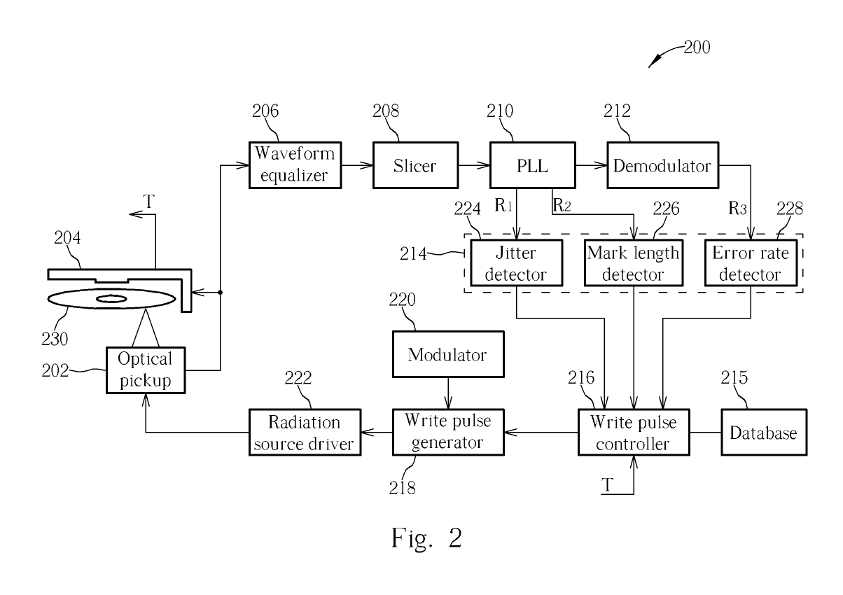

FIG. 2 shows an optical storage device 200 according to an exemplary embodiment. In this embodiment, the optical storage device 200 includes an optical pickup 202, an optical medium reception unit 204, a waveform equalizer 206, a slicer 208, a phase locked loop (PLL) 210, a demodulator 212, a signal quality measuring unit 214, a write pulse controller 216, a modulator 220, a write pulse generator 218, and a radiation source driver 222. The optical pickup 202 is used for writing marks on the optical medium with a write radiation level of emitted light and for reading marks on the optical medium 230 with a read radiation level of emitted light. The radiation source driver 222 supplies the optical pickup 202 with the appropriate radiation power as controlled by the write pulse generator 218. When a new optical medium 230 is received by the optical medium reception unit 204, if the particular optical medium type is unrecognized and the optical storage device has not already determined an optimal write strategy for the optical medium 230, the write pulse controller 216 determines a write strategy for the new optical medium 230 according to signal quality values measured by the signal quality measuring unit 214. In this embodiment, the signal quality measuring unit 214 includes a jitter detector 224, a mark length detector 226, and an error rate detector 228; however, as will be explained, different signal quality measuring units could also be utilized according to an exemplary embodiment.

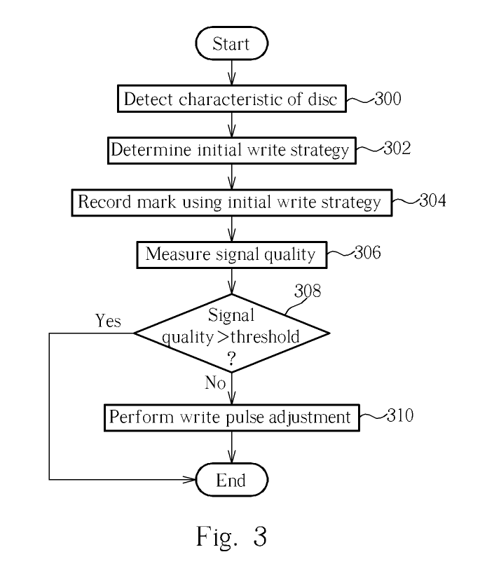

FIG. 3 shows a flowchart describing a method of determining a write strategy according to an exemplary embodiment. The following description of the flowchart of FIG. 3 will be made with respect to the optical storage device 200 shown in FIG. 2. However, this is for example only and, as will be readily apparent to a person of ordinary skill in the art, the steps of FIG. 3 need not be performed by hardware having the exact structure of FIG. 2. Other embodiments are possible. Additionally, provided that substantially the same result is achieved, the steps of the flowchart of FIG. 3 need not be in the exact order shown and need not be contiguous, that is, other steps can be intermediate. In this embodiment, the write pulse controller 216 repetitively adjusts and then measures the write strategy in real time to thereby determine an optimal write strategy for a new optical medium 230. As shown in FIG. 3, determining a write strategy for the new optical medium 230 in this embodiment includes the following steps:

Step 300: Detect a characteristic of the optical disc 230 such as an optical medium type or a recording speed.

Step 302: Determine an initial write strategy according to the detected characteristic of the optical disc 230.

Step 304: Record a mark using the initial write strategy.

Step 306: Measure signal quality values when reproducing a signal corresponding to the mark from the optical disc 230 written using the initial write strategy in step 304.

Step 308: Does the signal quality value have a quality being greater than a predetermined quality threshold? In other words, is the signal quality value measured in step 306 substantially optimal? If yes, end the write strategy calibration operation and use the initial write strategy for future write operations on this optical medium 230. Otherwise, proceed to step 310.

Step 310: Adjust the initial write strategy by performing a write pulse adjustment including adjusting a first edge of a write pulse in the initial write strategy by a first time unit to thereby generate an adjusted write strategy.

When a new optical medium 230 is received by the optical medium reception unit 204, the optical storage device 200 performs a write strategy calibration operation using the method shown in FIG. 3 to determine an optimal write strategy for the particular optical medium 230. With reference to FIG. 2, the optical medium reception unit 204 receives an optical medium 230 and detects a characteristic of the optical disc 230 (step 300). For example, in step 300 the optical medium reception unit 204 detects a medium type and a recording speed of the received optical disc 230. As shown in FIG. 2, the optical medium reception unit 204 outputs a signal T corresponding to the detected medium type and recording speed to the write pulse controller 216. Next, the write pulse controller 216 determines an initial write strategy according to the detected characteristic of the optical disc 230 (i.e., the detected medium type and recording speed received via signal T). In order to determine the initial write strategy, the write pulse controller 216 can further include or be coupled to a database 215 within the optical storage device 200. The database 215 stores predetermined initial write strategies for a plurality of different possible characteristics of optical mediums 230. In this way, the write pulse controller 216 can determine the initial write strategy according to the recoding speed and the type of the optical disc 230 by referring to the database 215.

At step 304, the write pulse controller 216 writes a mark on the optical disc 230 utilizing the initial write strategy determined in step 302. And at step 306, the optical storage device 200 reads the mark written on the optical disc 230 in step 304 to thereby generate a reproduced signal, and measures a signal quality of the reproduced signal. In the exemplary block diagram shown in FIG. 2, the optical storage device 200 generates three signals R1, R2, R3. However, as will be apparent to a person of ordinary skill in the art after reading this description, other embodiments having only a single signal or other numbers of signals are also possible. As shown in FIG. 2, the signal quality measuring unit 214 includes the jitter detector 224 for measuring jitter values of the first signal R₁ when reading the test data from the optical disc, the mark length detector 226 for measuring mark length errors of the second signal R₂ when reading the test data from the optical disc 230, and the error rate detector 228 for measuring error rates of the third signal R₃ when reading the test data from the optical disc 230. Other embodiments having different signal quality detectors or different numbers of signal quality detectors within the signal quality measuring unit 214 are also possible.

Step 308 is performed to determine if further optimization of the initial write strategy is required. That is, for some optical media 230, the initial write strategy determined by the write pulse controller 216 may be sufficient for write operations. If the signal quality value measured in step 306 is not of sufficient magnitude (i.e., the signal quality is not above a predetermined threshold), operations proceed to step 310. At step 310, the write pulse controller 216 performs a write pulse adjustment in order to generate an adjusted write strategy. In this embodiment, signal quality values corresponding to the new mark written using the adjusted write strategy are measured by the signal quality measuring unit 214 and the write pulse adjustment is repetitively performed until an optimal write strategy is determined at step 308.

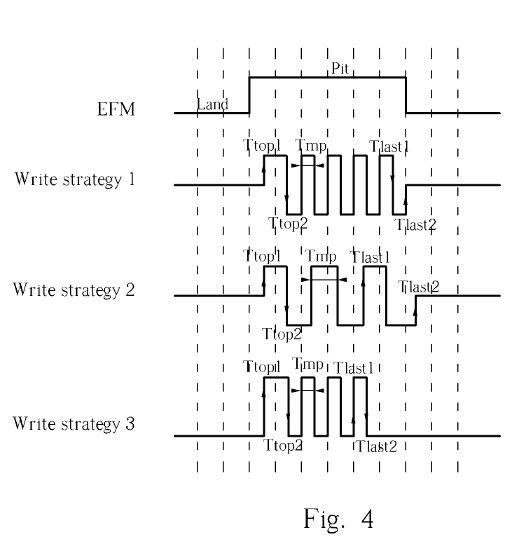

FIG. 4 is a write pulse waveform diagram of three different exemplary write strategies undergoing adjustment by the write pulse controller 216 according to the embodiment. For example, the first write strategy (Write Strategy 1) could correspond to a low speed optical write operation on a multi-times re-writable optical medium such as a DVD-RW, the second write strategy (Write Strategy 2) could correspond to a high speed write operation on a multi-times re-writable optical medium such as a DVD-RW, and the third write strategy (Write Strategy 3) could correspond to a low speed write operation on a write-once optical medium such as a DVD-R. In this embodiment, the write pulse controller 216 adjusts a leading pulse being formed by edges Ttop1 and Ttop2, or a final pulse being formed by edges Tlast1 and Tlast2 of the initial write strategy. Additionally, the write pulse controller 216 adjusts a duration (Tmp) of a middle pulse of the initial write strategy being between the leading pulse and the final pulse by fixing a first edge of the middle pulse and adjusting a second edge of the middle pulse.

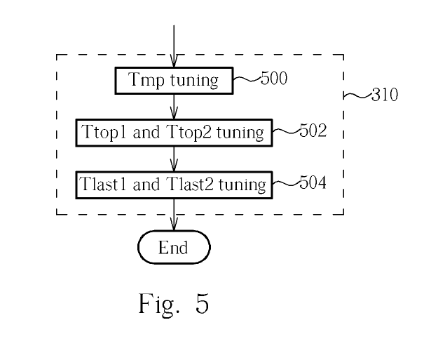

FIG. 5 shows a flowchart describing performing the write pulse adjustment (step 310) when determining the write strategy according to an exemplary embodiment. Provided that substantially the same result is achieved, the steps of the flowchart of FIG. 5 need not be in the exact order shown and need not be contiguous, that is, other steps can be intermediate. In this embodiment, performing the write pulse adjustment includes the following steps made in reference to the write pulse waveform diagram of FIG. 4:

Step 500: Tune the Tmp duration to adjust a mark thickness.

Step 502: Tune the first edge Ttop1 and the second edge Ttop2 in the first pulse of the write strategy to adjust a front shape and duration of the mark.

Step 504: Tune the first edge Tlast1 and the second edge Tlast2 in the last pulse of the write strategy to adjust a rear shape and duration of the mark.

Please note that when adjusting these three groups of parameters: Tmp at step 500, Top1 and Top2 at step 502, and Tlast1 and Tlast2 at step 504, the order of adjustment steps 500, 502, 504 is not constrained. Different orders can be used according to design requirements. Additionally, it may only be necessary to adjust one or two of the groups to obtain an optimal write strategy. That is, other embodiments are possible where only one or two of the steps 500, 502, 504 are used within the write pulse adjustment (step 310).

Moreover, the signal quality measuring step 306 is not limited to only detection of jitter. Instead or in addition, other signal quality measuring techniques such as BER or mark length error could also be used. In the case of detecting jitter, firstly, use a predetermined write strategy to write a mark (step 304), and then read back the mark and measure the jitter (steps 306). If the value is less than a predetermined threshold value (ex. 9%), end the adjustment. If the value is greater than the threshold value, next perform a write strategy calibration operation (step 310).

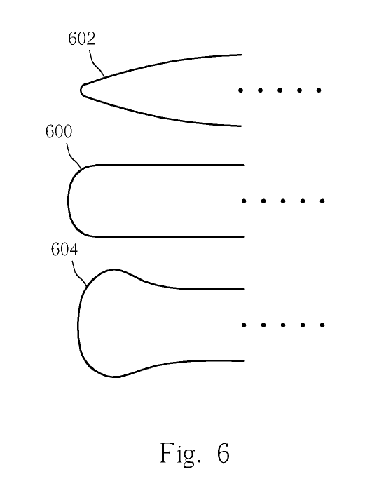

FIG. 6 shows a diagram illustrating changes in the shape of marks written to the optical medium by adjusting the first edge Ttop1 and the second edge Ttop2 in the first pulse according to step 502 of FIG. 5. As shown in FIG. 6, the relative positions of Ttop1 and Ttop2 can determine the shape of the front end of the mark written to the optical medium 230. For example, in FIG. 6, a first mark 600 shows an optimal front-end shape for a mark. When the relative positions of Ttop1 and Ttop2 are not optimal, the shape of the front end of the mark written on the optical medium 230 will begin to distort. As shown, a second mark 602 has a front end being too sharp, and 604 shows a mark having a front end being too dull. Moreover, by moving both Ttop1 and Ttop2 forward together or backward together, the length of the mark can be determined.

The write pulse controller 216 makes similar changes to the ending shape of the marks written to the optical medium 230 by adjusting the first edge Tlast1 and the second edge Tlast2 in the last pulse at step 504. The relative positions of Tlast1 and Tlast2 can determine the shape of the last edge in the mark written to the optical medium 230. The effect of changes to Tlast1 and Tlast2 are similar to that of Ttop1 and Ttop2 shown in FIG. 6, and moving both Tlast1 and Tlast2 forward together or backward together can also determine the length of the mark. Because the operation of step 504 is substantially equal to the previous description of step 502, a repeated explanation of step 504 is hereby omitted.

In order to simultaneously adjust both the mark length and the mark leading edge shape, according to this embodiment, Ttop1 and Ttop2 are adjusted together as a pair using the following equations:
Ttop1=Ttop1_{—}i+Ni*deltaT (Equation 1)
Ttop2=Ttop1+A*deltaT+Mi*deltaT, (Equation 2)

where Ttop1_i is an initial value determined according to the initial write strategy, A is a factor determined according to the initial write strategy, the parameters Mi and Ni can be set equal to . . . , −2, −1, 0, 1, 2, . . . , etc; and deltaT is a predetermined unit of time.

In order to simultaneously adjust both the mark length and the mark last edge shape, according to this embodiment, Tlast1 and Tlast2 are also adjusted together as a pair using the following equations:
Tlast1=Tlast1_{—}i+Oi*deltaT (Equation 3)
Tlast2=Tlast1+B*deltaT+Pi*deltaT, (Equation 4)

where Tlast1_i is an initial value determined according to the initial write strategy, B is a factor determined according to the initial write strategy, the parameters Oi and Pi can be set equal to . . . , −2, −1, 0, 1, 2, . . . , etc; and deltaT is a predetermined unit of time.

Equation 1 and Equation 2 can be utilized to perform the following adjustments to the write strategy:

1. Moving both Ttop1 and Ttop2 forward (or backward) together controls the length of the mark.

2. Adjusting the positions of Ttop1 and Ttop2 relative to each other controls the shape of the front edge of the mark.

Equation 3 and Equation 4 can be utilized to perform the following adjustments the write strategy:

1. Moving both Tlast1 and Tlast2 forward (or backward) together controls the length of the mark.

2. Adjusting the positions of Ttop1 and Ttop2 relative to each other controls the shape of the back edge of the mark.

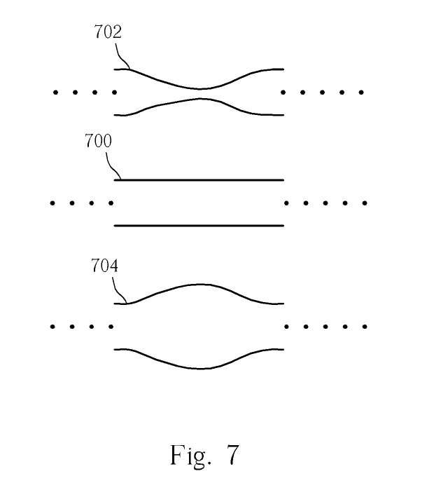

FIG. 7 shows a diagram illustrating changes in the shape of marks written to the optical medium 230 by adjusting the time duration Tmp of a middle pulse according to step 500 of FIG. 5. As shown in FIG. 7, the variable Tmp can determine the thickness of a mark written to the optical medium 230. For example, a first mark 700 has the proper thickness as a result of the optimal time duration Tmp. When Tmp is not the optimal time duration, the mark thickness will begin to diverge from the proper thickness. For example in FIG. 7, a second mark 702 shows a mark having too narrow a middle portion, and a third mark 704 shows a mark having too thick a middle portion.

In order to adjust the width of the middle of the mark, Tmp is adjusted according to the following equation:
Tmp=Tmp_{—}I+Li*deltaT (Equation 5)

where the parameter Li can be set equal to . . . , −2, −1, 0, 1, 2, . . . , etc; deltaT is a unit of time, Tmp_I is set according to an optical medium material type and a burning speed of the particular optical medium 230 for which the write strategy is being determined. Additionally, in this embodiment, Equation 5 is used individually (i.e., not paired with the other equations) to adjust the width of the mark.

When the optical medium materials and the writing speed are fixed, a typical write strategy will have a very small change. Therefore, if suitable settings are chosen for the initial values of Tmp_i, Ttop1_i, Tlast1_i, A and B, by using the above mentioned grouped equation methods, the time for the automatic write strategy calibration operation and the writing area on the optical medium 230 are both greatly reduced. In this way, the embodiment provides a method and device suitable for fast and automatic write strategy calibration.

It should also be noted that the equations Ttop1=Ttop1_i+Ni*deltaT and Ttop2=Ttop1+A*deltaT+Mi*deltaT can also be rewritten as Ttop2=Ttop2_i+Ni*deltaT and Ttop1=Ttop2+A*deltaT+Mi*deltaT, respectively.

Likewise, the equations Tlast1=Tlast1_i+Oi*deltaT and Tlast2=Tlast1+B*deltaT+Pi*deltaT can also be rewritten as Tlast2=Tlast2_i+Oi*deltaT and Tlast1=Tlast2+B*deltaT+Pi*deltaT. Where Ttop2_i and Tlast2_i are predetermined initial values.

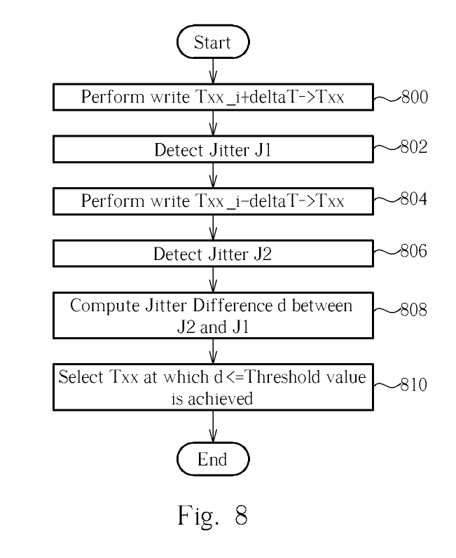

FIG. 8 shows a flowchart describing steps for performing the tuning operations 500, 502, and 504 of FIG. 5 according to a first embodiment. Provided that substantially the same result is achieved, the steps of the flowchart of FIG. 8 need not be in the exact order shown and need not be contiguous, that is, other steps can be intermediate. In this embodiment, performing a tuning operation includes the following steps:

Step 800: Perform write operation for Txx, where Txx is computed as Txx_i+deltaT and corresponds to one of Tmp, Top1, Ttop2, Tlast1 or Tlast2.

Step 802: Measure a first jitter value J1 for a reproduced signal corresponding to the Txx written in step 800.

Step 804: Perform write operation for Txx, where Txx is computed as Txx_i−deltaT.

Step 806: Measure a second jitter value J2 for a reproduced signal corresponding to the Txx written in step 804.

Step 808: Compute a jitter value difference d between J1 and J1.

Step 810: Select a final Txx when d less than or equal to a predetermined threshold value.

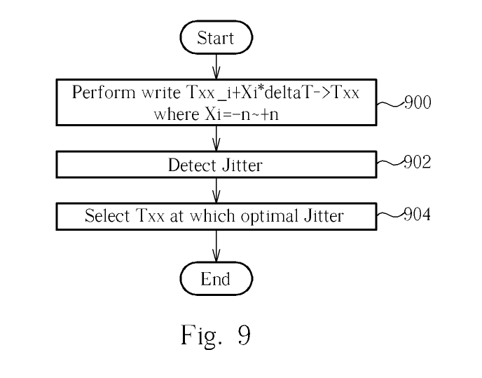

FIG. 9 shows a flowchart describing steps for performing the tuning operations 500, 502, and 504 of FIG. 5 according to a second embodiment. Provided that substantially the same result is achieved, the steps of the flowchart of FIG. 9 need not be in the exact order shown and need not be contiguous, that is, other steps can be intermediate. In this embodiment, performing a tuning operation includes the following steps:

Step 900: Perform write operation for Txx, where Txx is computed as Txx_i+Xi*deltaT, and where Xi=−n to +n, and Txx is equal to one of Tmp, Top1, Ttop2, Tlast1 or Tlast2.

Step 902: Measure jitter values for reproduced signals corresponding to each Txx written in step 900.

Step 904: Select a final Txx having substantially an optimal jitter value (i.e., the Txx having the lowest jitter value).

When performing the write pulse adjustment (step 310) in FIG. 3, the write pulse controller 216 can first adjust the Tmp value (step 500). According to different embodiments, the adjusting method for step 500 can be as shown in either FIG. 8 or FIG. 9. According to the adjusting method of FIG. 8, a write strategy is first used which has Txx=Txx_i+deltaT to write the mark (step 800), wherein Txx_i is an initial value and Txx can be Tmp, Ttop1, Ttop2, Tlast1 or Tlast2. A first jitter value J1 is measured at step 802, and then a write strategy is used which has Txx=Txx_i−deltaT to write the next mark (step 804). The measured jitter corresponding to this mark is referred to as J2 at step 806. At step 808, a jitter difference d is calculated between the two jitter value as d=|J1−J2|. The write pulse controller 216 repetitively uses different Txx values to perform the above-mentioned operations and calculates the jitter difference d in each iteration. When d is smaller than or equal to a predetermined threshold value (ex. 1%) the write controller 216 selects the Txx value and thereby obtains the optimal Txx write strategy (step 810).

According to the adjusting method of FIG. 9, the write pulse controller 216 directly uses a range for Xi being from +n to −n. For example, in one embodiment, n=−2, −1, 0, 1, 2. Afterwards, the write pulse controller 216 determines a resulting write strategy formed by using each value to write a mark (step 900), measures the jitter value for each mark written at step 902, and chooses the best (i.e., optimal) Txx write strategy (step 904).

By using the methods of FIG. 8 and FIG. 9, the Xi value can be adjusted in order to control different Tmp values. That is, the Tmp=Tmp_I+Li*deltaT adjustment can use the above-mentioned methods of FIG. 8 and FIG. 9 to obtain the optimal Li, and thereby obtain the optimal Tmp value.

As previously mentioned, Ttop1 and Ttop2 values can be adjusted together in as pair. In this situation, the methods of FIG. 8 and FIG. 9 can be performed in a dual loop fashion. That is all the values of Ttop1=Ttop1_i+Ni*deltaT are calculated for each value of Ttop2=Ttop1+A*deltaT+Mi*deltaT. In this way, the methods of FIG. 8 or FIG. 9 can be used to obtain the optimal Ni and Mi values, and thereafter the optimal Ttop1 and Ttop2 values can be determined. Likewise, the methods of FIG. 8 and FIG. 9 can be used to adjust the Tlast1 and Tlast2 values by making Tlast=Tlast1_I+Oi*deltaT and Tlast2=Tlast1+B*deltaT+I*deltaT. In this way, optimal Oi and Pi values can be obtained, and thereafter the optimal Tlast1 and Tlast2 values can be determined. Please note that because Tlast1 and Tlast2 can also be adjusted as a pair by performing the methods of FIG. 8 and FIG. 9 using a dual loop.

When encountering an unrecognized media 230, the embodiment performs a write pulse adjustment of an initial write strategy. The write pulse adjustment includes adjusting a first edge of a write pulse in the initial write strategy by a first time unit to thereby generate an adjusted write strategy. Signal quality values according to the adjusted write strategy are measured, and additional adjustments are made accordingly. By adjusting the first edge of the write pulse, the time for the automatic write strategy calibration operation and the writing area on the optical medium 230 are both greatly reduced. In this way, the embodiment provides a method and device suitable for fast and automatic write strategy calibration.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of determining a write strategy when storing data on an optical disc in an optical storage device, the method comprising:
detecting a characteristic of the optical disc;
determining an initial write strategy according to the detected characteristic of the optical disc;
adjusting the initial write strategy by performing a write pulse adjustment including adjusting a first edge of a write pulse in the initial write strategy by a first time unit to thereby generate an adjusted write strategy;
writing data on the optical disc utilizing the adjusted write strategy;
measuring reproduced signal quality values when reading the data from the optical disc; and
determining a write strategy according to the reproduced signal quality values.

2. The method of claim 1, wherein the write pulse adjustment further comprises adjusting a second edge that follows the first edge in the write pulse by a second time unit.

3. The method of claim 1, wherein the write pulse adjustment further comprises maintaining a time duration between the first edge and a second edge following the first edge in the write pulse within a predetermined range.

4. The method of claim 1, wherein detecting the characteristic of the optical disc further comprises detecting at least a type or a recording speed of the optical disc.

5. The method of claim 4, wherein determining the initial write strategy further comprises referring to a database being stored within the optical storage device to determine the initial write strategy according to the recording speed and the type of the optical disc.

6. The method of claim 1, further comprising measuring jitter values of a reproduced signal when reading the data from the optical disc, wherein the reproduced signal quality values correspond to the jitter values.

7. The method of claim 1, further comprising measuring error rates when reading the data from the optical disc, wherein the reproduced signal quality values correspond to the error rates.

8. The method of claim 1, further comprising measuring mark length errors when reading the data from the optical disc, wherein the reproduced signal quality values correspond to the mark length errors.

9. The method of claim 1, further comprising comparing a first reproduced signal quality value and a second reproduced signal quality value corresponding to two different adjusted write strategies; and
determining the optimum write strategy when a difference between the first reproduced signal quality value and the second reproduced signal quality value is less than or equal to a predetermined threshold value.

10. The method of claim 1, wherein the write pulse adjustment further comprises adjusting a leading pulse or a final pulse of the initial write strategy.

11. The method of claim 10, wherein the write pulse adjustment further comprises adjusting a middle pulse of the initial write strategy being between the leading pulse and the final pulse by fixing a first edge of the middle pulse and adjusting a second edge of the middle pulse.

12. An optical storage device comprising:
an optical medium reception unit for receiving an optical medium and detecting a characteristic of the optical disc;
an optical pickup for writing marks on the optical medium and reading data from the optical medium corresponding to the marks;
a write pulse controller being coupled to the optical pickup for determining an initial write strategy according to the detected characteristic of the optical disc ; adjusting the initial write strategy by performing a write pulse adjustment by adjusting a first edge of a write pulse in the initial write strategy by a first time unit to thereby generate an adjusted write strategy; writing data on the optical disc utilizing the adjusted write strategy; and determining a write strategy according to reproduced signal quality values; and
a signal quality measuring unit being coupled to the write pulse controller and the optical pickup for measuring reproduced signal quality values when reading the data from the optical disc.

13. The optical storage device of claim 12, wherein when performing the write pulse adjustment, the write pulse controller is further operative to adjust a second edge that follows the first edge in the write pulse by a second time unit.

14. The optical storage device of claim 12, wherein when performing the write pulse adjustment, the write pulse controller is further operative to maintain a time duration between the first edge and a second edge following the first edge in the write pulse within a predetermined range.

15. The optical storage device of claim 12, wherein the optical medium reception unit is further operative to detect at least a type or a recording speed of the optical disc.

16. The optical storage device of claim 15, wherein when performing the write pulse adjustment, the write pulse controller is further operative to refer to a database being stored within the optical storage device to determine the initial write strategy according to the recoding speed and the type of the optical disc.

17. The optical storage device of claim 12, wherein the signal quality measuring unit further comprises a jitter detector for measuring jitter values of a reproduced signal when reading the data from the optical disc, wherein the reproduced signal quality values correspond to the jitter values.

18. The optical storage device of claim 12, wherein the signal quality measuring unit further comprises an error rate detector for measuring error rates when reading the data from the optical disc, wherein the reproduced signal quality values correspond to the error rates.

19. The optical storage device of claim 12, wherein the signal quality measuring unit further comprises a mark length detector for measuring mark length errors when reading the data from the optical disc, wherein the reproduced signal quality values correspond to the mark length errors.

20. The optical storage device of claim 12, wherein the write pulse controller is further operative to compare a first reproduced signal quality value and a second reproduced signal quality value corresponding to two different adjusted write strategies; and
wherein the write pulse controller is further operative to determine the optimum write strategy when a difference between the first reproduced signal quality value and the second reproduced signal quality value is less than or equal to a predetermined threshold value.

21. The optical storage device of claim 12, wherein when performing the write pulse adjustment, the write pulse controller is further operative to adjust a leading pulse or a final pulse of the initial write strategy.

22. The optical storage device of claim 21, wherein when performing the write pulse adjustment, the write pulse controller is further operative to adjust a middle pulse of the initial write strategy being between the leading pulse and the final pulse by fixing a first edge of the middle pulse and adjust a second edge of the middle pulse.
